(19) United States
(12) Patent Application Publication
(10) Pub. No.: US 2024/0241152 A1
(43) Pub. Date: Jul. 18, 2024

(54) Method for processing a measuring probe for recording surface properties or for modifying surface structures in the sub-micrometer range and measuring probe

(71) Applicants: HELMHOLTZ-ZENTRUM BERLIN FÜR MATERIALIEN UND ENERGIE GMBH, Berlin (DE); MAX-PLANCK-GESELLSCHAFT ZUR FÖRDERUNG DER WISSENSCHAFTEN E.V., München (DE)

(72) Inventors: Christopher Seiji KLEY, Berlin (DE); Martin MUNZ, Berlin (DE); Beatriz ROLDÁN CUENYA, Berlin (DE)

(73) Assignees: HELMHOLTZ-ZENTRUM BERLIN FÜR MATERIALIEN UND ENERGIE GMBH, Berlin (DE); MAX-PLANCK-GESELLSCHAFT ZUR FÖRDERUNG DER WISSENSCHAFTEN E.V., München (DE)

(21) Appl. No.: 18/290,775

(22) PCT Filed: Jul. 20, 2022
(86) PCT No.: PCT/EP2022/070414

§ 371 Date: Jan. 21, 2024

(30) Foreign Application Priority Data
Jul. 21, 2021 (EP) 21186969.8

(51) Int. Cl. G01Q 70/14; G01Q 70/16

(52) U.S. Cl. CPC G01Q 70/14; G01Q 70/16

(57) ABSTRACT

The invention relates to a method for processing a measuring probe which is intended for detecting surface properties or for modifying surface structures in the sub-micrometer range. The method comprises at least the following steps. First, providing a precursor containing molecules polymerizable by light or electron beams and a measuring probe comprising at least one carrier with a tip having an upper end opposite the carrier and a light or electron source for emitting light or electron beams with a wavelength and intensity, which fulfil an energy input at least required for polymerization of the precursor and means for variable positioning of the light or electron source and a control file and an electronic data processing system, wherein the control file describes at least a part of the surface of the measuring probe and serves to control a change in position of the light or electron source. In the following step, the measuring probe is covered with the precursor and the measuring probe is arranged in the beam path of the light or electron beams, whereupon the precursor is exposed to the light or electron beam at several positions that touch each other and are specified in the control file, leaving out the tip of the measuring probe. The unexposed areas of the precursor are then removed by means of a water or solvent bath or controlled air or gas flow and, if necessary, the areas polymerized by exposure are finally developed. The invention also includes measuring probes which are manufactured using the inventive method.

### TECHNICAL AREA

The invention relates to a method for processing a measuring probe for detecting surface properties or modification of surface structures, in particular with a resolution in the sub-micrometer range, as is given, for example, in scanning probe microscopy, and to a measuring probe according to the method of the invention, which is used, for example, for characterizing electrical, chemical, photo-electrochemical and catalytic properties of the surfaces of condensed matter or their local modification, in particular on surfaces of solids.

### STATE OF THE ART

Measuring probes of the type according to claim 1 are used to detect the properties of surfaces, in particular in the sub-micrometer range, e.g. in scanning probe microscopy (SPM), which includes atomic force microscopy (AFM), scanning tunneling microscopy (STM) or scanning electrochemical microscopy (SECM). They mainly consist of a spring beam that can be suspended on one side with a tip arranged on it, which is located near the free end (i.e. opposite a suspension) of the spring beam. The so-called tip is formed from a predominantly conical or pyramidal body with a height above a base surface that coincides with a surface of the spring beam and has an upper end that is opposite the attachment to the spring beam. The spring beam and tip can be manufactured monolithically, i.e. in one piece, or be made up of several components, usually two, namely the spring beam and the tip. The entirety of spring beam and tip is also referred to as cantilever, or more specifically, AFM cantilever (AFM spring beam). However, the measuring probes covered by the invention can also be those that have a tip that is not arranged on a cantilever, but on another carrier or the tip is machined out of the carrier itself.

The properties of measuring probes and their modifications for special applications are crucial for the high-resolution, highly sensitive and quantitative recording of surface properties, as can be seen in article 1 by I. W. Rangelow (Scanning proximity probes for nanoscience and nanofabrication, Microelectronic Engineering, Vol. 83, 2006, 1449-1455). The vast majority of characterizations of the electrical properties of condensed matter (solids and liquids) using SPM are performed in air or vacuum, as described in the paper 2 by R. A. Oliver (Advances in AFM for the electrical characterization of semiconductors, Rep. Prog. Phys., Vol. 71, 2008, 076501 (37 pp)) for the AFM method. Characterizations of the electrical, electrochemical and catalytic properties of solid surfaces in liquids as well as the photo-electrical, photo-electrochemical and photo-catalytic properties using AFM and STM are of particular interest for applications in biology, medicine or chemistry. Examples of this are presented in article 3 by P. L. T. M. Frederix et al. (Assessment of insulated conductive cantilevers for biology and electrochemistry, Nanotechnology, Vol. 16 (2005) 997-1005). The latter areas of application place special demands on the design and manufacture of suitable measuring probes.

In addition to the characterization of solid-liquid interfaces, the measuring probes, in particular cantilevers, are also used for the manipulation of surfaces, e.g. for micro/nano lithography. The tips of the cantilevers are used, for example, to move or remove individual atoms from surfaces in order to create a designated surface structure. This can be achieved purely mechanically by scratching or indenting or, for example, by applying an electrical voltage, provided this leads to electrochemical interactions in the tip-sample contact. However, the cantilevers can also have special additional constructive elements, such as microfluidic channels, for carrying out lithography processes, as described in the article 4 by A. Meister et al. (FluidFM: Combining atomic force microscopy and nanofluidics in a universal liquid delivery system for single cell applications and beyond, Nano Letters, Vol. 9, No. 6, 2009, 2501-2507).

The use of AFM and STM to characterize electrical, chemical and/or (photo-) electrochemical and (photo-) catalytic properties of solid surfaces, including in liquids, is of particular interest in catalysis, battery and photovoltaic research as well as for the development of surfaces for electrochemical sensors. For this application, the measuring probes used must be electrically conductive at least at the tip and must be equipped with appropriate means for voltage tapping/current conduction to tap a voltage or current to be detected with the tip. In the simplest case, the entire cantilever, i.e. including tip and spring beam, is designed to be conductive by using appropriate materials. In order to minimize or even eliminate the occurrence of leakage currents and thus improve the spatial resolution of the conductive tips, but also to increase the measuring sensitivity and accuracy, these are electrically insulated in the area of the tip up to its last, upper end. Several methods have been proposed in the state of the art for the manufacture of such measuring probes with electrical insulation.

In the article 5 by C. Kranz et al. (Integrating an ultramicroelectrode in an AFM cantilever: Combined technology for enhanced information, Analytical Chemistry, Vol. 73, No. 11, 2001, 2491-2500) a method is presented in which a measuring probe in the form of a cantilever (spring beam and tip) made of silicon nitride is first coated with chromium by RF sputter deposition and then with gold. This conductive coating is then provided with an electrically insulating coating of silicon nitride, which is applied using plasma-enhanced chemical vapor deposition (PECVD). All three coatings are also applied to the tip of the cantilever. In order to adjust the electrical conductivity at the tip of the cantilever, it is subsequently trimmed in several steps using a focused ion beam (FIB). A detailed description of this manufacturing process for cantilevers is also disclosed in EP 1 290 431 B1.

In the paper 6 by I. V. Pobelov et al. (Electrochemical current-sensing atomic force microscopy in conductive solutions, Nanotechnology, Vol. 24, 2013, 115501 1-10), a similar approach is disclosed in which a commercially available cantilever is first provided with a Ti/Au/Ti layer sequence (sputter deposition) and then with a layer of silicon nitride, followed by a final layer of chromium (by PECVD). Here too, the tip is also coated and then exposed with a focused ion beam and finally with wet etching.

US 2020/124636 A1 describes a cantilever for measurement in liquids that has two special features. Firstly, the chip carrying the cantilever, which is connected to a ribbon cable for an electrical connection, is integrated into the solution approach. The ribbon cable is also designed as a handle for handling the cantilever. Secondly, an insulating coating of the cantilever including the tip with the polymer Parylene C using the Gorham process is described. In the Gorham process, a starting dimer is first passed through a pyrolysis chamber where it breaks down into monomers, which then strike a cooled substrate on the surface of which polymerization occurs. The process takes place in a vacuum and always affects the entire object to be coated. As is probably not explained in the patent specification US 2020/124636 A1, the upper end of the tip of the cantilever is therefore also coated after the process and must subsequently be freed from the coating using ablative methods (e.g. laser ablation or ion beam cutting) to enable electrically conductive contact between the tip apex and the sample surface. The Gorham process is described in paper 7 by B. J. Kim and E. Meng (Micromachining of Parylene C for bioMEMS, Polymer Advanced Technologies, Vol. 27, 2016, pp. 564-576).

An alternative is to use probes that are manufactured as described in the article 8 by K. Yum et al. (Individidual Nanotube-Based Needle Nanoprobes for Electrochemical Studies in Picoliter Microenvironments, ACS Nano, Vol. 1(5), 2007, pp. 440-448). Here, a pointed metal wire is fitted with a nanotube at the tip. Both are then coated with gold (sputter deposition) and then coated with an electrically insulating layer of polymers by electropolymerization. Finally, the tip is exposed using focused ion beam cutting.

The manufacturing processes known from the state of the art for measuring probes for the characterization of electrical and/or electrochemical properties of surfaces of solids or liquids or for the manipulation of surfaces, such as in lithography, have in common a coating process consisting of several steps with subsequent exposure of the tip of the measuring probe by invasive procedures. The process of exposing the tip is associated with a high risk of loss of quality or even the risk of losing the tip apex of the cantilever.

### DESCRIPTION

The task of the present invention is to provide a method for processing a measuring probe for detecting surface properties or modifying surface structures in the sub-micrometer range, as an alternative to the methods known from the prior art, which is also gentler on a tip of the measuring probe and is also simplified and enables differentiated functionalization. Furthermore, it is the task of the invention to provide a measuring probe which can be manufactured in a simplified manner and can be functionalized in a differentiated manner.

The problem is solved by the features of claims 1 and 11. Advantageous embodiments are subject of the subclaims.

The inventive method for processing a measuring probe for detecting surface properties or modifying surface structures in the sub-micrometer range has at least the following steps.

In a first step, the resources, precursors and the measuring probe to be processed required for carrying out the procedure are provided. The order of provision is not essential for carrying out the procedure, i.e. it is arbitrary.

In detail, at least the following is provided.

A measuring probe is provided which comprises at least one tip and a carrier, the tip having an upper end which is opposite the carrier. The measuring probe is suitable for detecting surface properties or modifying surface structures in the sub-micrometer range. The design required for this is sufficiently known to the skilled person and can be found, for example, in the articles 1-10 and 12 mentioned in this publication.

In one embodiment of the inventive method, the measuring probe provided is a so-called cantilever, i.e. it consists of a tip and a spring beam as a carrier, which can be manufactured monolithically or composed of several parts.

The cantilever can be any cantilever for use in scanning probe microscopy or for lithography systems. The cantilevers are usually between 10 μm and 900 μm long, with the longest extension along the spring beam. Cantilevers suitable for use in the inventive method can be purchased commercially or manufactured by suitable manufacturing processes of MEMS technology and microfabrication technology, such as photo- or electron beam lithography and anisotropic chemical etching of silicon wafers.

According to another embodiment, the cantilever provided is designed to detect current or voltages on surfaces or in liquids and thus to detect electrical, chemical or (photo-) electrochemical and (photo-) catalytic properties on surfaces. In this embodiment, at least the tip is formed from a conductive material, at least partially and at least at its upper end. The current or voltage applied to the tip must also be able to be tapped by the cantilever, i.e. means must be provided for conducting the current/tapping the voltage, such as conductor paths or cables. In the simplest case, the entire cantilever, tip and spring beam, is made of conductive material.

The material from which the electrically conductive component of the cantilever of the aforementioned embodiment is made has a specific resistance in the order of magnitude of at most 10² Ohm·cm. Materials which satisfy this property and are advantageously used for the manufacture of cantilevers are those from the group consisting of doped silicon, aluminum, gold, copper, platinum, silver or doped diamond, as corresponds to one embodiment. Alternatively, a cantilever made of non-conductive or weakly conductive material can be provided with an electrically conductive coating, for example of doped diamond, metals (such as aluminum, gold, iridium, platinum, silver, copper or tungsten), as well as their alloys or metal compounds such as titanium nitride (TiN) or tungsten carbide (WC/W₂C).

In a further embodiment of the inventive method, the measuring probe provided is formed from a tip and a carrier, wherein the tip is formed from a wire and the carrier is formed from a micrometer-scale platform comprising the wire. The platform can be ring-shaped or disk-shaped so that the longitudinal axis of the wire is perpendicular to the plane of the platform. The platform is made of an electrically insulating material and is (photo-) electrochemically inert. In the area between the platform and the end of the wire opposite the pointed end, the electrical insulation can be produced using a conventional process, such as partial immersion in a solution containing suitable polymer molecules. In order to provide a micrometer-scale platform, a kind of base could also be produced as an alternative to a disk placed on the wire, by controlled milling into the wire surface, for example by ion beam (focused ion beam (FIB) milling) or chemical etching.

Furthermore, a precursor is provided which contains as precursor at least molecules polymerizable by light or electron beams as starting product.

This precursor is photo-polymerizable with respect to the fact, that it can be polymerized by light rays. By irradiation with electromagnetic radiation, such a precursor undergoes a physicochemical transformation, which means an increase in the degree of cross-linking or the degree of polymerization. In addition to the polymerizable molecules, such a precursor mixture also contains photoinitiators and fillers. To activate the physicochemical processes, a photon energy or wavelength and intensity is required, which is determined by the polymerizing molecules or the photoinitiators, in that it is above a so-called exposure threshold value of the precursor mixture. The underlying physicochemical mechanisms and material requirements as well as the required photoinitiators, fillers, etc. are complex and varied and are described, for example, in the article 9 by J. V. Crivello and E. Reichmanis (Photopolymer materials and processes for advanced technologies, Chemistry of Materials, Vol. 26, 2014, 533-548). In the following, when precursor mixtures are mentioned, it is not explicitly stated for each case which additives, in particular photoinitiators, are required for polymerization and which these could be. In addition to the main matrix and the photoinitiators, the precursor formulation can also contain reactive diluents and crosslinking-active additives, as described, for example, in the paper 10 by X. Zhang et al. (Acrylate-based photosensitive resin for stereolithographic three-dimensional printing, J. Appl. Polym. Sci. 2019, 47487). The skilled person is referred here to a consultation of the prior art.

The precursor can also be given by molecules that polymerize through the energy input of an electron beam. In this case, polymerization is triggered by the effect of initiators created by the ionizing radiation. The initiators are free radicals and radical ions generated by electron beams, whereby the formation of ion pairs is also important. Easily decomposing additives can also be added to support the reaction, similar to initiators in the case of polymerization by electromagnetic radiation. However, this is usually unnecessary due to the ionizing effect of electron beams and the associated generation of free radicals.

The coating of the measuring probe with the precursor, in a next step of the method, is to be carried out by immersion in or covering with liquid formulations of the precursor or a precursor mixture or spraying, dusting, printing (ink printing) or other suitable methods. The coating may only be carried out after the positioning of the measuring probe (further step). The measuring probe provided is at least partially coated with the precursor mixture.

The selection of suitable precursors for a particular application depends on any special requirements for the measuring probes coated with them. For a requirement for measuring probes according to the method, it is advantageous to select precursor mixtures for the method which are electrically insulating after polymerization. The electrical insulation is required for the insulation of the tip, except at its upper end, in order to minimize or even eliminate electrical leakage currents and thus improve the spatial resolution when characterizing surfaces, but also to increase the measurement sensitivity and accuracy. All materials that have a specific resistance of 10⁸ Ω·cm or higher are to be regarded as electrically insulating in the sense of the invention. Further fundamental criteria for the selection of suitable precursors or precursor mixtures are the shrinkage behaviour in the course of the polymerization or crosslinking reaction and the structural stability of the resulting polymer as a function of the ambient conditions, such as temperature and surrounding medium and here in particular also with respect to a wide pH range.

Also accessible to the invention is the additional use of precursors for photoinduced mass transport, as described, for example, in paper 11b by Z. Sekkat and S. Kawata (see below).

The coating of the measuring probe with the precursor is carried out at least with a layer thickness that ensures a layer thickness of a polymer formed by the polymerization of at least 10 nm.

For a next embodiment, the precursor mixture advantageously comprises as photopolymerizable resin one selected from the group consisting of the following classes of compounds:

Acrylates, epoxy resins, fluorocarbons, phenolic resins, amides, esters, imides, styrene, (poly)sulphides, urethanes, vinyls, silicones, xylylenes (incl. parylenes), UV-curable dimethylsiloxanes and carbamate/methacrylate-based compounds. Among the acrylates, multifunctional acrylate monomers should be mentioned in particular, such as “pentaerythritol tetraacrylate” and “pentaerythritol triacrylate”. An example of an epoxy resin is a bis-phenol-A-novolac with a group functionality of 8.

Depending on the intended application of the measuring probes, a precursor mixture comprising one or more molecular components and possibly also nano- or micro-scale fillers such as nanoparticles can also be selected for the coating of the measuring probes instead of an electrically insulating polymer as the product of polymerization, as also corresponds to one embodiment, in which such additives impart to the product one of the properties of electrical conductivity, magnetic susceptibility, high mechanical stability or rigidity, high thermal stability or optical properties such as transparency and reflectivity or (electro)catalytic activity or suitability for electrochemical sensing, including photo-electrochemical sensing, according to one embodiment. With the addition of nanoparticles, e.g. of gold or silver, the polymer can also be produced with metallic nanostructures which, under suitable conditions, enable the formation of surface plasmons, in particular localized surface plasmon polaritons (LSPP) or propagating surface plasmon polaritons (PSPP). A polymer functionalized in this way gives the measuring probe according to the method a functionality for vibrational spectroscopy, in particular Raman spectroscopy, in particular surface enhanced Raman spectroscopy (SERS), as well as plasmon-enhanced catalysis. If the measuring probe is coated with such an excellent precursor mixture, moreover at selected locations, this enables, for example, the formation of conductive paths and the like in the polymerization step of the process. The coating of the measuring probe with a functionalized polymer as described may have to be carried out on a conductive polymer that has already been deposited. The coating of the measuring probe with a functionalized polymer may not be deposited as a continuous layer on the previously deposited lower layer of an electrically conductive polymer. Functional areas of this type, in the size of a few square nanometers to micrometers, are advantageous for sensors, especially in liquids, as they provide a two-dimensional pore structure with a high surface-to-volume ratio and the increased possibility of adsorption and interaction, for example of molecules from the liquid phase. An alternating coating with differently functionalized polymers, e.g. for insulation, electrical conductivity, pH stability or different polymers, to form a layer sequence is also possible.

The polymerization of the precursor is carried out by light or electron beams emitted by a light or electron beam source, which must be provided.

Light in the sense of the invention is electromagnetic radiation in a wavelength range from the UV range to the IR range, corresponding to 100 nm to 10 μm. In particular, lasers such as titanium-sapphire femtosecond lasers with a wavelength of 800 nm are used for photopolymerization. In the paper 11a by N. Tsutsumi et al. (Influence of baking conditions on 3D microstructures by direct laser writing in negative photoresist SU-8 via two-photon polymerization, Journal of Laser Applications, Vol. 29, 2017, 042010) and 11b by Z. Sekkat and S. Kawata (Laser nanofabrication in photoresists and azopolymers, Laser & Photonics Review, Vol. 8(1), 2014, pp. 1-26) provide detailed and comprehensive information on possible light sources and lasers that can be used.

For photopolymerization of a corresponding precursor comprising at least one photopolymerizable resin, a light source is provided which has a photon energy (wavelength) and light intensity (fluence) which is sufficient for photopolymerization of the photosensitive molecules of the selected precursor or of the photoinitiator present in a precursor mixture. Means for guiding (alignment to the measuring probe to be processed) and shaping (beam cross-section, intensity, etc.) light beams from the light source, such as lenses, lens systems, collimators, collimating masks, mirrors, choppers, filters, etc., are included in the provision of the light source.

The light source can be a laser or a light-emitting diode, for example. In an advantageous manner, the light source is a laser, as also explained above.

For the polymerization of a corresponding precursor by electron beam, an electron source must be provided, such as that available in an electron microscope that permits an acceleration voltage of 200 kV or higher.

In order to carry out the polymerization of the precursor or a precursor mixture at more than just one location and thus produce a coherent region of the polymerized product that is extended in at least two dimensions, the measuring probe and the light or electron beam must be translated (moved) in relation to each other and, if necessary, also pivoted (rotated about a centre of gravity in the measuring probe). In the vast majority of cases, this is achieved by moving the light or electron beam using means for variable positioning of the light or electron source, which must be provided. The variable positioning takes the form of translation and/or tilting of the light or electron beams or the sources. The means for variable positioning advantageously consist of motors or actuators that can perform steps in the micro and nano range. The smallest step size determines the possible resolution or fineness for details of two- or three-dimensional shapes produced. Although the displacement or tilting of a sample table on which the measuring probe is to be positioned is more complex, this is also possible with the same means as those for displacing/tilting the light or electron beam, provided that this does not cause the liquid precursor mixture to flow off in order to ensure processing in two or three dimensions (2D or 3D). It is essential that the position of the light or electron beam can be changed in relation to the measuring probe.

In a second step, the measuring probe to be processed must be positioned in the beam path of a light or electron beam emitted by the light or electron source. When printing on the tip of the measuring probe, its tip points in the direction of the incident beam. The arrangement may also have to be carried out in a specific position in relation to a focus of the light or electron beam. The latter is particularly important when using a laser as a light source. The position of the focus can be used to influence the depth at which polymerization takes place in a layer of precursor molecules, which can be used for structuring the polymer as a product of polymerization.

In a third step, a control file and an electronic data processing system, on which the control file for controlling the translation and tilting of a beam incident on a measuring probe and, if necessary, a change in the position of a focus, are provided. For this purpose, at least part of the surface of the measuring probe is recorded in the control file so that it is available as a digital model with absolute positions in the control file as an electronic file. The control file is used to move and possibly also tilt the measuring probe relative to the incident light or electron beam or vice versa, in which it serves as the basis for computer control of means for translation and tilting. Control files must be created using optical or electron microscopic imaging of the real object, in this case the measuring probe. In addition to a laser intended for photopolymerization, a further optical imaging system or an external electron microscopic imaging system may need to be provided for this purpose. In a process that is standardized with regard to the shaping of the measuring probe and its positioning, a control file obtained once in advance may be reused, so that the third step can also precede the two previous steps and only the control file itself needs to be provided.

In the following step, the precursor applied to the measuring probe, which can also be present in a precursor mixture, is exposed at several contacting positions. The contacting positions result from the size of the focal spot (focus) of the light or electron beam and the resulting polymerized area, in which the translation or pivoting only takes place by such an amount or the focal spots are positioned in such a way that the polymerized areas overlap so that a continuous polymerized 2D or 3D area results. By means of control by the electronic data processing system, i.e. on the basis of the control file, the precursor is exposed along a specific path in order to build up the polymer coating layer by layer (slicing). In general, each layer is in turn composed of lines (hatching). The trajectory is determined by means of control software on the electronic data processing system, into which the control file has previously been read. The inventive method is to be addressed as a location-selective method, in which only selected areas of a provided volume of the precursor are exposed, depending on the predetermined desired shape of the product.

Another parameter to be specified by the control file is the position of the focus of the light or electron beam in relation to the surface of the measuring probe. By shifting the focus away from the surface, polymerization of the precursors can take place in such a way that cavities and channels are formed between the polymerized product (polymer) and the surface of the measuring probe or in the polymer itself, as also corresponds to one embodiment, which can be used as microfluid channels and reservoirs, for example, and which can be represented in particular by embedding at least one structured layer between a bottom layer and a top layer. The surface of the polymerized product (polymer) can also be structured in this way. By structuring with channel-like cavities according to the inventive method, in addition to microfluidics for measuring probes that provide only one channel, several channels and possibly reservoirs can also be represented and these possibly also in correspondence with each other, so that, for example, solutions can be mixed in situ on the measuring probe, for example as part of a lab-on-a-chip realization of measurements or reactions in a liquid environment.

According to the invention, the coating of the measuring probe in the form of a cantilever, as corresponds to one embodiment, is carried out on at least one part of the carrier, which in the case of a cantilever is given by the spring beam, in particular on its tip-side surface. It is not necessary to coat the entire side of the carrier or cantilever. However, the entire surface of the carrier or cantilever can be insulatingly coated, including the side surfaces and the opposite surface. Polymerization always takes place with the upper end of the tip cut out. However, the coating is also applied to part of the side/shell surface(s) of the tip. The recessed part of the tip is at least 5 nanometers and at most 50% of the vertical extent of the tip (height), i.e. at most 5 micrometers in the case of a tip height of 10 micrometers. In a particularly advantageous way, the recessed area around the uppermost end of the tip is ≤7 μm², assuming that the apex of the tip can be approximately described by the surface of a hemisphere with a radius of at most 1 micrometer.

The exposure of the precursor or the precursor mixture is carried out in particular, as is the case in one embodiment, as two-photon polymerization, in which this is based on so-called two-photon absorption. This involves the simultaneous absorption of two photons by a molecule or atom, which then enters an energetically excited state. With two-photon polymerization (also abbreviated as 2PP), higher resolutions can be achieved, especially in depth, i.e. along the direction of irradiation. In the paper 12 by S. Maruo and S. Kawata (Two-photon-absorbed photopolymerization for three-dimensional microfabrication, Proceedings IEEE The Tenth Annual International Workshop on Micro Electro Mechanical Systems. An Investigation of Micro Structures, Sensors, Actuators, Machines and Robots, 1997, pp. 169-174) explains two-photon polymerization in more detail. Two-photon polymerization is carried out using a laser as a light source.

The exposed areas can also be finalized by further development steps, such as thermal treatment. This serves, for example, to increase the degree of cross-linking or to improve the mechanical or other physical properties.

After the exposure step, the unexposed areas of the precursor or precursor mixture are removed in a further step. The latter is done gently by washing with or immersing in water or a suitable solvent. Depending on the precursor, removal by a stream of air or an inert gas can also be used for this purpose. Furthermore, the exposed areas can also be developed, for example by immersing the measuring probe in a suitable developer solution.

According to claim 11, in a first embodiment, the inventive method provides a measuring probe according to the invention for detecting surface properties or for modifying surface structures in the sub-micrometer range, which comprises at least one carrier and a tip arranged thereon. The carrier and tip can be monolithic or made up of components.

The electrically conductive measuring probe is characterized in that it is coated at least partially and with a recess in an upper part of the tip opposite the carrier with a polymer which is formed as a product from a precursor polymerizable by light or electron beam by photopolymerization. The layer thickness is at least 10 nm. In an advantageous manner, the polymer is electrically insulating (i.e. with a specific resistance of 10⁸ Ω·cm or higher), so that the measuring probe can be used to detect electrical/electrochemical/catalytic/electrocatalytic properties of surfaces or liquids. The recessed part of the tip is at least 5 nanometers and at most 50% of the vertical extension of the tip (height), i.e. at most 5 micrometers in the case of a tip height of 10 micrometers. In a particularly advantageous way, the recessed area around the uppermost end of the tip is ≤7 μm², assuming that the apex of the tip can be approximately described by the surface of a hemisphere with a radius of at most 1 micrometer.

The polymer is in particular the product of the photopolymerization of a resin from the group of photopolymerizable resins acrylates, epoxy resins, fluorocarbons, phenolic resins, amides, esters, imides, styrene, (poly-)sulfides, urethanes, vinyls, silicones, xylylenes (incl. parylenes), UV-curable dimethylsiloxanes and carbamates/methacrylates as precursor, as also corresponds to one embodiment.

In a special embodiment, the measuring probe is in the form of a cantilever, which is provided with means for tapping current or voltage with a conductor path whose width is smaller than the total width of the cantilever.

Here, the conductor path can either run completely along the tip side of the cantilever or partially along the opposite side (which is to be addressed as the rear side) of the cantilever, which generally serves as a reflection surface for a laser beam of the optical component, e.g. of a detection system used in atomic force microscopy, or one of the edge surfaces connecting the tip side of the cantilever to its rear side.

In particular, it can be advantageous to provide the rear side, which serves as the reflective surface in the application of the cantilever, uncoated in order to avoid a reduction in optical reflectivity. In general, the reflective surface is arranged near the free end of the cantilever in order to ensure a high detection sensitivity for deflections of the tip from its rest position during use.

In a further special embodiment of the measuring probe according to the invention, only the tip-side surface of a cantilever is coated as a measuring probe, leaving out the upper end of the tip, while edge surfaces of the cantilever remain uncoated and are thus available, for example, for equipping with conductor paths.

One possible embodiment also comprises a special version of a measuring probe according to the invention, in which a cantilever comprises a chip carrying it, which is partially coated with the polymer polymerized by light or electron beams, whereby the electrically insulating coating is not present on the surface that establishes a connection to an electrical circuit or a voltage source for electrical contacting with a cable, a terminal or a conductor path.

In a next possible embodiment of the measuring probe according to the invention, it is provided with conductive paths which are formed from an electrically conductive polymer and wherein the conductive polymer is formed from a precursor polymerized by light or electron beams. The polymer is made electrically conductive by additives resulting from a precursor mixture. A measuring probe formed in this way is in turn also to be provided for processing in the inventive method.

The inventive method can also be used to form a measuring probe whose tip-side surface is initially completely coated, including the tip, with an electrically conductive polymer, which in turn is then coated with a polymer according to the inventive method, leaving out the tip. In particular, this coating is made with polymers in which molecular or particle-like additives in the precursor give the product one of the properties of electrical conductivity, magnetic susceptibility, high mechanical stability or rigidity, high thermal stability or optical properties such as transparency and reflectivity or electrocatalytic and catalytic activity or suitability for electrochemical and photo-electrochemical sensor technology, as corresponds to one embodiment.

In the presence of nanoparticles, e.g. of gold or silver, in the functionalized polymer, which is designed as a non-continuous layer on the previously deposited lower layer of an electrically conductive polymer, as also corresponds to one embodiment, the measuring probe is suitable for use in vibrational spectroscopy, in particular Raman spectroscopy.

In one embodiment, the measuring probe is equipped with channel-like cavities for microfluidics, which are provided with side walls by the polymer, which is formed from a precursor that can be polymerized by light or electron beam through photopolymerization.

The measuring probe according to the invention can be provided by a measuring probe in which the tip is formed from a wire and the carrier is formed from a disk surrounding the wire. The wire is advantageously cylindrical or conical and is provided at an upper end with a sharp tip which serves to scan a sample surface. The coating with an electrically insulating polymer according to the inventive method is present in the area between the platform and the upper end of the tip, excluding the latter. The platform can have a ring or disk shape, so that the longitudinal axis of the wire is perpendicular to the platform. The platform should be made of an electrically insulating material and be electrochemically inert. In the area between the platform and the end of the wire opposite the pointed end, the electrical insulation can be produced using a conventional method, such as partial immersion in a solution containing suitable polymer molecules. In order to provide a micrometer-scale platform, a kind of base could also be produced as an alternative to a disk placed on the wire, by controlled milling into the wire surface, for example by ion beam (focused ion beam (FIB) milling) or chemical etching.

With the inventive method, a measuring probe for detecting surface properties or for modifying surface structures in the sub-micrometer range can be processed in a reduced number of steps compared to the prior art, and in particular in a simplified manner, and can thus be used for a special application, e.g. the detection of electrical, chemical or (photo-) electrochemical and (photo-) catalytic properties of surfaces. The measuring probes according to the invention are thus characterized by cost-effective production, flexibility and higher quality with regard to the formation of the tip.

In addition to the reduction of work steps and the associated time savings, the inventive method leads to a higher quality of the tip apex (upper end of the tip), since it replaces the exposure required there, which is not residue-free or even leads to an unwanted modification of the tip apex and, if necessary, its conductive coating, with a non-invasive, gentle method in which the apex (uppermost) area of the tip remains free of the coating.

In addition, the process according to the invention offers the possibility of functionalizing the coating produced by polymerization with molecular or particle-like additives and additionally structuring it, e.g. by creating cavities, and thus providing a wide range of cost-effective measuring probes with high-quality tips.

An increase in throughput in the production of measuring probes can also be achieved with the inventive method, in which at least two or more measuring probes are processed simultaneously.

### EXAMPLES

The invention will be explained in more detail in 5 examples and with the aid of five figures.

### The Figures Show:

FIG. 1: Schematic representation of a measuring probe in the form of a cantilever, processed according to the method of the invention, in oblique view.

FIG. 2: Schematic representation of a measuring probe processed according to the method of the invention in the form of a cantilever with conductor path, in oblique view.

FIG. 3: Schematic representation of a measuring probe processed according to the method of the invention in the form of a cantilever, with conductor path and additional conductive surfaces in a) oblique view of the side of the cantilever opposite the tip and b) oblique view of the tip side of the cantilever.

FIG. 4: Schematic representation, including two cross-sections (CS #1, CS #2), of a measuring probe in the form of a cantilever processed according to the method of the invention, with two microfluidic channels along the tip-side surface of the cantilever and two side surfaces of the tip jacket up to the upper end edge of the coating.

FIG. 5: Schematic representation of a measuring probe with a tip and a carrier processed according to the method of the invention.

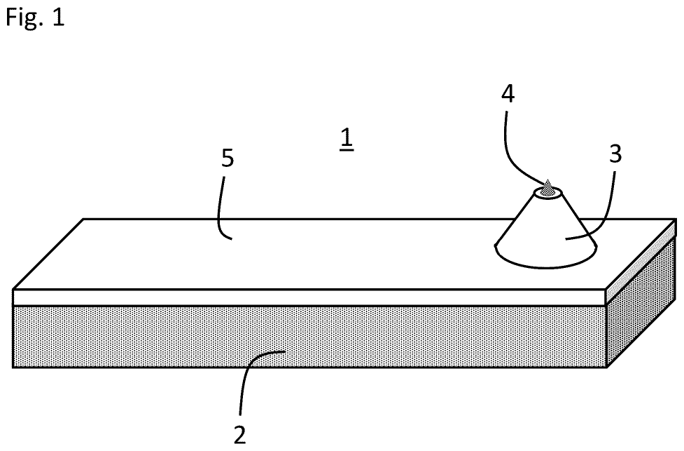

FIG. 1 schematically shows a first example of a measuring probe processed using the inventive method, in this case in the form of a cantilever 1. The cantilever 1 consists of a spring beam 2 and a tip 3, which in the example are made of doped silicon that has a specific resistance in the order of 10⁻² Ohm·cm. The spring beam 2 is coated with a polymer 5 with a layer thickness of 10 nm on the side on which the tip 3 is also arranged. The coating also covers the lower part of the tip 3, but not the upper end 4, so that the upper end of the tip 4 (the apex) is exposed. The polymer is electrically non-conductive and has a resistivity of about 10⁸ Ω·cm or higher. In the embodiment example, the polymer is to be polymerized by two-photon polymerization according to the method of the invention, starting from a precursor mixture based on the negative photoresist SU-8 (Microchem Co., Westborough, MA, USA) with admixtures of a suitable solvent for viscosity adjustment and the photoinitiator triarylsulfonium salt dissolved in propylene carbonate.

A first example of the inventive method is as follows.

In the first example, the coating according to the method of the invention is applied to a cantilever 1, which is electrically conductive due to a Pt coating. The length, width and thickness of the spring beam 2 are approximately 225, 27.5 and 3 micrometers. The height of the pyramidal tip is 15 micrometers and the radius of curvature of the tip apex (upper end of the tip) is 30 nanometers according to the specification.

In the embodiment example, the process according to the invention is implemented as two-photon polymerization (2PP). The cantilever 1 is coated using a so-called 3D printer. The 3D printer provides a light source for emitting light beams in the form of a laser and the means for variable positioning of the light beam or laser beam. The measuring probe is positioned in the 3D printer in a focus of the laser beam. In the embodiment example, the cantilever 1 to be coated is covered with a liquid precursor mixture, which polymerizes when illuminated with a suitably pulsed infrared laser beam in the area of the laser focus and thus changes locally from the liquid to the solid phase by polymerization. Typically, the front end of the optical system of the laser, a lens, is immersed in the liquid precursor mixture (immersion), so that a meniscus is formed between the foremost lens surface of the optical system of the laser and the liquid precursor mixture.

A 3D model of the structure to be printed is created as a control file using an electronic data processing system and then displayed layer by layer using software (slicing). Each layer is in turn built up line by line (hatching) in order to determine the trajectory of the laser focus, which systematically builds up the structure of the polymer to be formed along this path from bottom to top through polymerization. Accordingly, the so-called writing process starts on the tip-side surface of the cantilever 1 and then moves layer by layer along the height axis of the tip 3. Before the writing process, the cantilever 1 is attached to a flat substrate (sample holder table) and the surface position is read into the control file in coordinates using an optical system. This requires an accuracy in the sub-micrometer range, especially in the area of the tip 3. The slicing and hatching distances as well as the writing speed are selected in such a way that the required level of detail is achieved, particularly in the area of the finest components, i.e. tip 3 in this case. The slicing and hatching distances are 100 nm and the writing speed 1 mm/s in this example. Optionally, larger components can be written with correspondingly larger slicing and hatching distances and a higher speed in order to limit the total write time to a realistic level.

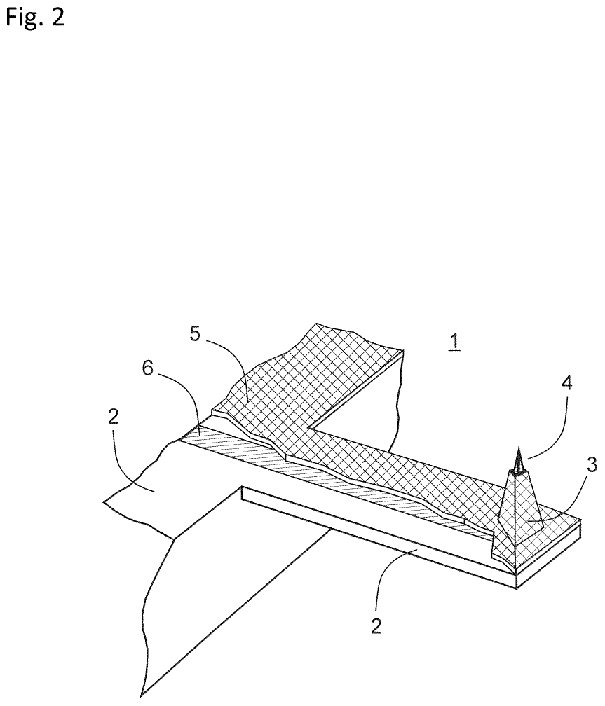

FIG. 2 shows a further example of a measuring probe according to the invention. The measuring probe consists of a cantilever 1 with a conductor path 6 along its tip-side surface and the surface of the chip 2 that carries the cantilever. The electrically insulating cover layer 5 extends over the entire tip-side cantilever surface and the lateral surface of the AFM tip, with a relatively small area around the tip apex 4 being left out. The tip apex is electrically connected to the conductor path 6.

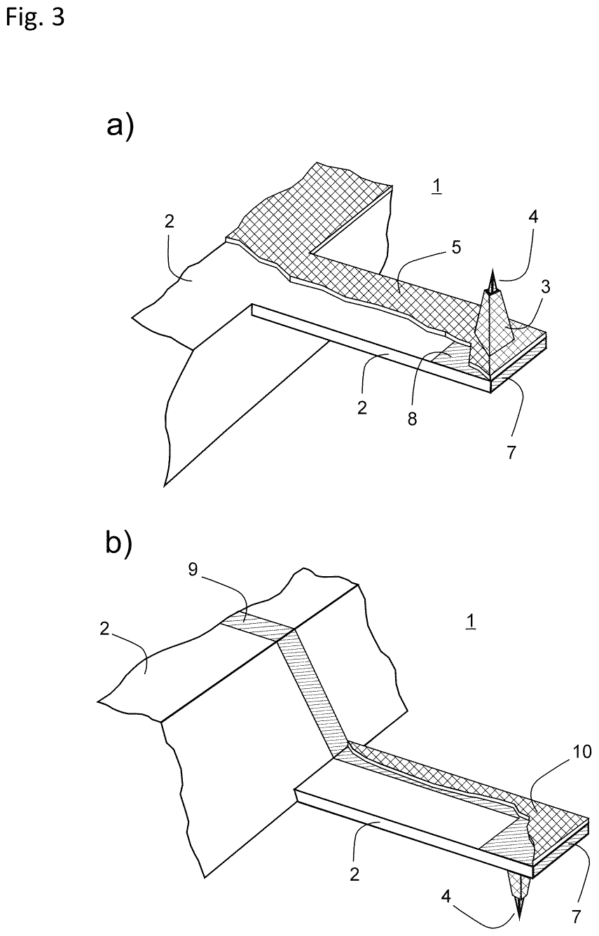

FIG. 3 shows a third example of a measuring probe according to the invention. The measuring probe consists of a cantilever 1 with a conductor path 9 along the reflector-side surface, the front edge surface 7, a tip-side surface in the vicinity of the tip 8 and the entire tip surface. The electrically insulating cover layer 5 extends over the entire cantilever surface and the outer surface of the tip, with a relatively small area around the tip apex 4 being left out. The electrically insulating cover layer 10 extends over the entire reflector-side surface of the cantilever. The tip apex is electrically connected via the conductive surfaces 7 and 8 as well as via the conductor path 9, which continues from the cantilever via the chip 2, which carries the cantilever.

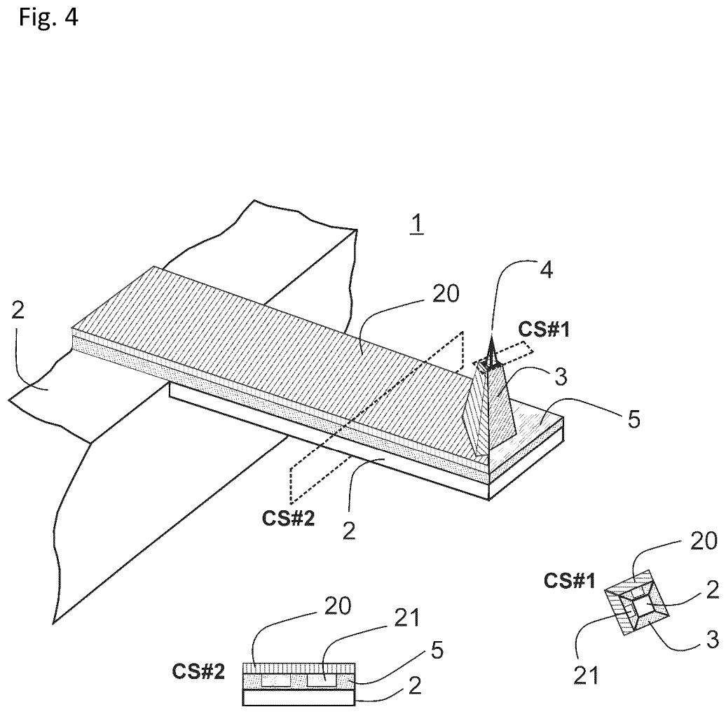

A fourth embodiment is shown in FIG. 4. The measuring probe according to the invention consists of a cantilever 1 with two microfluidic channels 21 along the tip-side surface and two side surfaces of the tip jacket. The microfluidic channels 21 extend from the cantilever further over the chip 2, which carries the cantilever, where they can optionally also connect further microfluidic components, such as reservoirs. The microfluidic channels 21 are embedded in the covering layer 5, which can be electrically insulating in particular and which extends over the entire surface of the cantilever and the lateral surface of the tip 3, whereby a relatively small area around the tip apex 4 is left out. Those surfaces in which microfluidic channels 21 are integrated are sealed on the outside with a cover layer 20.

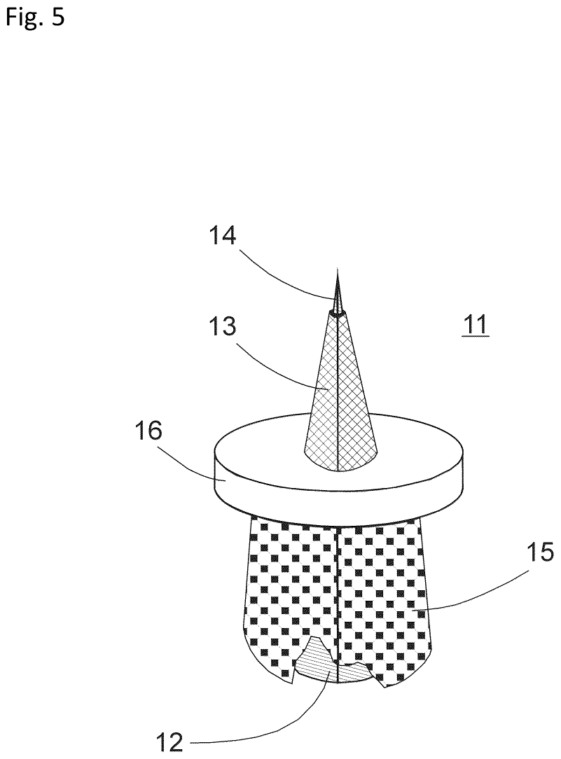

A further embodiment example is shown in FIG. 5. The measuring probe according to the invention comprises a conical tip 11 at one front end, which is provided with an electrically insulating coating except for the area around the apex 14 of the tip. In the area between an annular or disk-shaped platform 16, the coating 13 is to be produced using the inventive method, in particular to avoid covering the apex. In the area below the disk-shaped platform, the coating 15 is to be produced on the wire surface 12 using a conventional process. The platform itself is also electrically insulating. However, this could also be partially coated with an electrically insulating polymer using the inventive method.

1. Method for processing a measuring probe for detecting surface properties or for modifying surface structures in the sub-micrometer range, comprising at least the following steps
providing
of a precursor containing molecules that can be polymerized by light or electron beam;
a measuring probe comprising at least one support with a tip having an upper end opposite the support;
a light or electron source for emitting light or electron beams with a wavelength and intensity that meet a minimum required energy input for polymerization of the precursor;
means for variable positioning of the light or electron source;
a control file and an electronic data processing system, the control file describing at least a part of the surface of the measuring probe and serving to control a change in position of the light or electron source;
covering the measuring probe with the precursor and positioning the measuring probe in the beam path of the light or electron beam;
exposure of the precursor with the light or electron beam at several touching positions specified in the control file, leaving out the tip of the measuring probe and subsequently
removal of unexposed areas of the precursor using a water or solvent bath or controlled air or gas flow.

2. Method according to claim 1,
characterized in that
the measuring probe is provided in the form of a cantilever, comprising at least a tip and a spring beam.

3. Method according to claim 1,
characterized in that
the tip of the measuring probe is formed from a wire and the carrier from a platform surrounding the wire.

4. Method according to claim 1,
characterized in that
the tip of the measuring probe provided is conductive at least at the end opposite the carrier and the measuring probe is equipped for tapping current or voltage applied to the tip.

5. Method according to claim 1,
characterized in that
the precursor is mixed in a mixture with additives, the additives being suitable for imparting to a polymer at least one of the properties of electrical conductivity, magnetic susceptibility, high mechanical stability or rigidity, high thermal stability or optical properties such as transparency and reflectivity or (electro-)catalytic activity or suitability for electrochemical sensor technology.

6. Method according to claim 5,
characterized in that
the additives of the precursor are in the form of nanoscale fillers.

7. Method according to claim 4,
characterized in that
the conductive part of the tip is formed at least partially from a material from the group consisting of doped silicon, aluminum, gold, iridium, copper, platinum, silver, copper, tungsten, titanium nitride, tungsten carbide or doped diamond.

8. Method according to claim 1,
characterized in that
the precursor contains, as photopolymerizable resin, at least one from the group of the compound classes acrylates, epoxy resins, fluorocarbons, phenolic resins, amides, esters, imides, styrene, (poly)sulfides, urethanes, vinyls, silicones, xylylenes (incl. parylenes), UV-curable dimethylsiloxanes and carbamates/methacrylates.

9. Method according to claim 1,
characterized in that
the exposure of the precursor mixture with a light or electron beam is carried out at several contacting positions specified in the control file, and with the tip of the measuring probe cut out whereas the positions specified in the control file are partially spaced apart from a surface of the measuring probe in contiguous areas, so that in particular channel-like cavities for microfluidics are formed.

10. Method according to claim 1,
characterized in that
the precursor is polymerized with a laser beam as a two-photon polymerization.

11. Measuring probe for detecting surface properties or for modifying surface structures in the sub-micrometer range, comprising at least a carrier and a tip,
characterized in that
the measuring probe is at least partially coated, leaving out a part of the tip, with a polymer formed from a precursor polymerizable by light or electron beam by photopolymerization.

12. Measuring probe according to claim 10,
characterized in that
the polymer is formed as a product of the photopolymerization of a resin from the group of photopolymerizable resins acrylates, epoxy resins, fluorocarbons, phenolic resins, amides, esters, imides, styrene, (poly)sulfides, urethanes, vinyls, silicones, xylylenes (incl. parylenes), UV-curable dimethylsiloxanes and carbamates/methacrylates as precursor.

13. Measuring probe according to claim 10,
characterized in that
channel-like cavities for microfluidics are formed on the measuring probe by the polymer, which is formed from a precursor polymerizable by light or electron beam by photopolymerization.

14. Measuring probe according to claim 10,
characterized in that
the measuring probe is given as a cantilever and the cantilever is provided with a conductor path as a means for tapping current or voltage, the width of which is smaller than the total width of the spring beam of the cantilever.

15. Measuring probe according to claim 11,
characterized in that
only the tip-side surface of the cantilever is coated, leaving out the upper end of the tip, with edge surfaces of the cantilever being uncoated.

16. Measuring probe according to claim 10,
characterized in that
the measuring probe is provided with at least one conductor path which is formed from an electrically conductive polymer and wherein the electrically conductive polymer, which is formed from a precursor which can be polymerized by light or electron beam and to which electrically conductive additives are added, is formed by photopolymerization.

17. Measuring probe according to claim 16,
characterized in that
the measuring probe is coated at least on the tip-side surface with an electrically conductive polymer which is formed by photopolymerization from a precursor which can be polymerized by light or electron beam and to which electrically conductive additives are added, and this conductive layer is in turn coated at least partially and leaving out a part of the tip with a polymer which is formed by photopolymerization from a precursor which can be polymerized by light or electron beam and to which at least one additive is added.

18. Measuring probe according to claim 17,
characterized in that
nanoparticles of gold or silver in the functionalized polymer, which is not designed as a continuous layer on the previously deposited lower layer of an electrically conductive polymer, the measuring probe is suitable for use in vibrational spectroscopy, in particular Raman spectroscopy.

19. Measuring probe according to claim 10,
characterized in that
the tip is formed from a wire and the support from a platform surrounding the wire.
